(19) United States
(12) Patent Application Publication
(10) Pub. No.: US 2013/0002986 A1
(43) Pub. Date: Jan. 3, 2013

(54) DISPLAY DEVICE

(75) Inventors: Shinya Kadowaki, Osaka (JP); Takeshi Ishida, Osaka (JP); Fumie Kunimasa, Osaka (JP); Kazuya Kaida, Osaka (JP)

(73) Assignee: Sharp Kabushiki Kaisha, Osaka-shi ,Osaka (JP)

(21) Appl. No.: 13/634,203

(22) PCT Filed: Mar. 3, 2011
(86) PCT No.: PCT/JP2011/001246

§ 371 Date: Sep. 11, 2012

(30) Foreign Application Priority Data
May 18, 2010 (JP) 10/2010-113910

(51) Int. Cl. F21V 9/16; G02F 1/13357; F21V 8/00

(52) U.S. Cl. 349/65; 362/84; 362/611; 349/62

(57) ABSTRACT

A display device includes: a light source unit configured to emit light from a light emitting surface; and a phosphor layer (120) having a plurality of phosphors (123R, 123G) provided on a light-emitting side of the light source unit so as to correspond to pixels, and configured to absorb the light emitted from the light source unit and produce fluorescence of a predetermined wavelength. A bottom reflective layer (125) is provided on the side of the light source unit with respect to the phosphor layer (120) at least in regions where the phosphors (123R, 123G) are formed.

### TECHNICAL FIELD

The present invention relates to display devices that provide color display, and more particularly to high luminance or low power consumption display devices having improved utilization efficiency of light emitted from a light source.

### BACKGROUND ART

Liquid crystal display (LCD) devices are widely used as displays of televisions, office automation (OA) apparatuses such as a personal computer, portable information apparatuses such as a mobile phone and a personal digital assistant (PDA), etc., because of their small thickness and low power consumption.

The LCD device includes a liquid crystal panel and a backlight unit attached to the back side of the liquid crystal panel. The liquid crystal panel is typically formed by an array substrate having switching elements such as thin film transistors (TFTs), a counter substrate placed so as to face the array substrate and having formed thereon color filter layers of three colors, namely red (R), green (G), and blue (B), and a liquid crystal layer formed between the substrates. The LCD device provides color display by using a phenomenon in which the alignment state of liquid crystal molecules changes by turning on/off electrodes corresponding to pixels. By using this phenomenon, transmittance of incident light from the backlight is adjusted on a pixel-by-pixel basis, and the transmitted light transmits through the colored portions of the color filter layers, whereby color display is provided.

In order to convert the wavelength of light incident on the liquid crystal panel from the backlight by using the color filters, such as in the case where the incident light from the backlight is transmitted through the red color filters, green and blue components of the light transmitted through the color filters are absorbed by the red color filters, and only a red component of the light is transmitted through the red color filters. Thus, two thirds of the incident light from the backlight is absorbed by the color filters, and resulting low utilization efficiency of the light from the backlight.

In order to suppress such loss of the light of the backlight in the color filters, Patent Document 1 discloses an LCD device configured to transmit light of the backlight through color filters after transmitting the light through phosphors each emitting light of the same color as a corresponding one of the color filters. According to Patent Document 1, only visible light corresponding to the color of each color filter is incident on that color filter, whereby light loss in the color filters can be significantly reduced.

Patent Document 2 describes an LCD device configured to provide RGB color display by directing blue light of a backlight into a phosphor layer, and obtaining the blue light as it is in blue pixels and exciting the blue light in red and green pixels to produce red fluorescence and green fluorescence.

### CITATION LIST

### Patent Document

PATENT DOCUMENT 1: Japanese Patent Publication No. 2001-100203
PATENT DOCUMENT 2: Japanese Patent Publication No. 2009-244383

### SUMMARY OF THE INVENTION

### Technical Problem

In the case of providing color display by using fluorescence of a predetermined wavelength produced by exciting light of a backlight by phosphors, the fluorescence produced in the phosphors has no directivity, and travels not only toward the display side from which the fluorescence is output (the side from which a displayed image is visually recognized), but also back toward the backlight. This reduces utilization efficiency of the fluorescence emitted from the phosphors.

In view of the above problem, it is an object of the present invention to provide a display device providing color display and having high luminance characteristics by improving utilization efficiency of light emitted from a light source.

### Solution to the Problem

A display device of the present invention includes: a light source unit configured to emit light from a light emitting surface; and a phosphor layer having a plurality of phosphors provided on a light-emitting side of the light source unit so as to correspond to pixels, and configured to absorb the light emitted from the light source unit and produce fluorescence of a predetermined wavelength, wherein a bottom reflective layer is provided at least on regions of the phosphor layer where the phosphors are formed, and is located on a side of the light source unit with respect to the phosphor layer.

According to the above configuration, the emitted light of the light source unit is absorbed by the phosphors of the phosphor layer and is thus converted to the fluorescence of the predetermined wavelength, whereby light of a desired color can be obtained. Accordingly, light loss is reduced as compared to a configuration in which light of a desired wavelength is output by transmitting emitted light of a light source unit through color filters. Specifically, in the case of transmitting emitted light of a light source unit through RGB color filters, light of blue and green wavelengths is blocked if only light of a red wavelength is transmitted through the red color filters. Thus, only a maximum of ⅓ of the emitted light can be transmitted to a display side. In the display device having the above configuration, however, the light wavelength is converted to a predetermined one by the phosphors, whereby light loss can be significantly reduced. Thus, high-luminance light emission can be obtained, and power consumption of the light source unit can be suppressed.

According to the above configuration, the bottom reflective layer is provided at least on the regions of the phosphor layer where the phosphors are formed, and is located on the side of the light source unit with respect to the phosphor layer. Thus, of the fluorescence of the predetermined wavelength, which is obtained by the phosphor layer, the light propagating toward the light source unit can be reflected to an opposite side from the light source unit by the bottom reflective layer. This improves fluorescence output efficiency, whereby high luminance characteristics can be obtained.

In the display device of the present invention, it is preferable that the plurality of phosphors be separated from each other by a partition wall having a sidewall that is tilted to have a tapered shape in cross section so that the partition wall is tapered toward a display side as viewed in cross section, and a side reflective layer be provided on the sidewall of the partition wall.

According to the above configuration, the phosphors are separated from each other by the partition wall, and the side reflective layer is provided on the sidewall of the partition wall. Thus, even if the fluorescence produced by the phosphors travels toward the partition wall, the fluorescence is reflected by the side reflective layer. Moreover, the sidewall of the partition wall, on which the side reflective layer is provided, is tilted to have a tapered shape in cross section so that the partition wall is tapered toward the display side as viewed in cross section. Thus, the light reflected by the side reflective layer is reflected toward the display side. Accordingly, the fluorescence produced by the phosphors can be directed toward the display side, whereby utilization efficiency of the fluorescence can be improved.

In the display device of the present invention, it is preferable that the light source unit emit light in a blue wavelength range.

According to the above configuration, since the light source unit is formed by using a light source configured to emit light in the blue wavelength range, the emitted light can be used as it is for blue display. Since the light in the blue wavelength range does not contain ultraviolet (UV) light, it is not necessary to block light in the UV range. Thus, higher light utilization efficiency can be obtained as compared to the case where white light is used as a light source. Moreover, due to a phenomenon (Stokes shift) in which a peak position of a fluorescence emission spectrum is located on the longer wavelength side than an excitation light emission spectrum because of energy loss of excitation light etc., the blue light having a short wavelength can be preferably used as excitation light that produces fluorescence of a color (e.g., red or green) having a longer wavelength than the blue light.

In the above configuration, high light utilization efficiency can be obtained by forming the light source unit by using a light source configured to emit light in the blue wavelength range. Thus, the above configuration is preferably used for a display device providing RGB color display, in which the pixels include red pixels, green pixels, and blue pixels, and the phosphor layer includes red phosphors placed so as to correspond to the red pixels, and configured to absorb light of a blue wavelength to emit fluorescence of a red wavelength, green phosphors placed so as to correspond to the green pixels, and configured to absorb the light of the blue wavelength to emit fluorescence of a green wavelength, and fillers placed so as to correspond to the blue pixels, and configured to transmit therethrough the light of the blue wavelength to an opposite side of the light source unit.

In the case where the light source unit of the display device of the present invention emits the light in the blue wavelength range, the bottom reflective layer may be a bandpass filter configured to transmit therethrough only the light in the blue wavelength range emitted from the light source unit.

According to the above configuration, the bandpass filter as the bottom reflective layer transmits therethrough only the light in the blue wavelength range emitted from the light source unit, the light emitted from the light source unit is incident on the phosphors through the bottom reflective layer. Moreover, the bandpass filter as the bottom reflective layer does not transmit light of any wavelength other than the blue wavelength range emitted from the light source unit. Thus, even if the fluorescence excited and produced by the phosphors travels toward the bottom reflective layer, this fluorescence cannot pass through the bottom reflective layer and is reflected toward the display side. This improves utilization efficiency of the light excited by the phosphors.

The bottom reflective layer may be comprised of a low refractive index material.

According to the above configuration, since the bottom reflective layer is comprised of the low refractive index material, a critical angle at which light is incident on the bottom reflective layer from the phosphors is reduced. Even if the light excited by the phosphors travels toward the bottom reflective layers, the light that is incident on the bottom reflective layer at an angle equal to or larger than the critical angle is totally reflected back to the phosphors. Thus, a large part of the incident light is totally reflected due to the small critical angle. Accordingly, a large part of the light excited by the phosphors can be directed toward the display side, whereby the light utilization efficiency is improved. Moreover, since the bottom reflective layer is formed as a single layer of the low refractive index layer, the bottom reflective layer can be provided at low cost.

It is preferable that the display device of the present invention further include an optical shutter unit provided on an opposite side of the phosphor layer from the light source unit, and configured to control on a pixel-by-pixel basis transmittance of emitted light of the phosphor layer to a display side.

According to the above configuration, the optical shutter unit, which controls on a pixel-by-pixel basis the transmittance of the emitted light of the phosphor layer to the display side, adjusts the transmittance of the emitted light of the phosphor layer on a pixel-by-pixel basis. Thus, a desired image can be displayed as a whole.

The display device having the above configuration is preferably used in the case where the optical shutter unit is configured so that two substrates are arranged so as to face each other with a liquid crystal layer interposed therebetween.

In this case, the light source unit may be of an edge light type that is formed by a light guide plate, and a light source provided on a lateral side of the light guide plate and configured to emit light toward the light guide plate, or of a direct type that is formed by a plurality of light sources arranged in parallel and configured to emit light toward the phosphor layer, or may be formed by an organic electroluminescence (EL) light-emitting body configured to emit light toward the phosphor layer.

The display device of the present invention may further include an optical shutter unit configured so that a light source-side substrate and a display-side substrate are arranged so as to face each other, and configured to control on a pixel-by-pixel basis transmittance of emitted light of the phosphor layer to a display side, wherein the phosphor layer may be formed on the light source-side substrate, and the light source unit may be placed on a side of the light source-side substrate with respect to the optical shutter unit.

According to the above configuration, since the optical shutter unit adjusts the transmittance of the emitted light of the phosphor layer on a pixel-by-pixel basis, a desired image can be displayed as a whole. Since the phosphor layer is formed on the light source-side substrate of the optical shutter unit, the phosphor layer need not be independently provided between the light source unit and the optical shutter unit, whereby the thickness of the LCD device can be reduced.

The display device having the above configuration is preferably used in the case where a liquid crystal layer is provided between the light source-side substrate and the display-side substrate.

In this case, the light source unit may be of an edge light type that is formed by a light guide plate, and a light source provided on a lateral side of the light guide plate and configured to emit light toward the light guide plate, or of a direct type that is formed by a plurality of light sources arranged in parallel and configured to emit light toward the phosphor layer, or may be formed by an organic EL light-emitting body configured to emit light toward the phosphor layer.

The display device of the present invention may further include an optical shutter unit configured so that a light source-side substrate and a display-side substrate are arranged so as to face each other, and configured to control on a pixel-by-pixel basis transmittance of emitted light of the phosphor layer to a display side, wherein the light source unit may be of an edge light type that is formed by a light guide plate, and a light source provided on a lateral side of the light guide plate and configured to emit light toward the light guide plate, and the phosphor layer may be formed on a side of the light guide plate which is located on the display side, so that the phosphor layer and the light source unit together form the light source-side substrate.

According to the above configuration, since the optical shutter unit adjusts the transmittance of the emitted light of the phosphor layer on a pixel-by-pixel basis, a desired image can be displayed as a whole. Since the phosphor layer and the light source unit together form the light source-side substrate of the optical shutter unit, each of the light source unit, the optical shutter unit, and the phosphor layer need not be provided independently, whereby the thickness of the LCD device can be reduced.

The display device having the above configuration is preferably used in the case where a liquid crystal layer is provided between the light source-side substrate and the display-side substrate.

### Advantages of the Invention

According to the present invention, the bottom reflective layer is provided at least on the regions of the phosphor layer where the phosphors are formed, and is located on the side of the light source unit with respect to the phosphor layer. Thus, the emitted light of the light source unit is absorbed by the phosphors of the phosphor layer and is thus converted to fluorescence of a predetermined wavelength, whereby light of a desired color can be obtained. Accordingly, light loss is reduced as compared to a configuration in which light of a desired wavelength is output by transmitting emitted light of a light source unit through color filters. According to the present invention, the bottom reflective layer is provided at least on the regions of the phosphor layer where the phosphors are formed, and is located on the side of the light source unit with respect to the phosphor layer. Thus, of the fluorescence of the predetermined wavelength, which is obtained by the phosphor layer, the light propagating toward the light source unit can be reflected to the opposite side from the light source unit by the bottom reflective layer. This improves fluorescence output efficiency, whereby high luminance characteristics can be obtained.

### BRIEF DESCRIPTION OF THE DRAWINGS

FIG. 1 is a schematic cross-sectional view of an LCD device according to a first embodiment.

FIG. 2 is a cross-sectional view of a phosphor layer of the first embodiment.

FIG. 3 is a schematic cross-sectional view of a liquid crystal panel of the first embodiment.

FIG. 4 is a schematic cross-sectional view of an LCD device according to a modification of the first embodiment (a first modification).

FIG. 5 is a schematic cross-sectional view of an LCD device according to a modification of the first embodiment (a second modification).

FIG. 6 is a cross-sectional view of a phosphor layer according to a modification of the first embodiment (a third modification).

FIG. 7 is a schematic cross-sectional view of an LCD device according to a second embodiment.

FIG. 8 is a cross-sectional view of a phosphor layer of the second embodiment.

FIG. 9 is a cross-sectional view of a phosphor layer of a modification of the second embodiment (a fourth modification).

FIG. 10 is a cross-sectional view of a phosphor layer of a modification of the second embodiment (a fifth modification).

FIG. 11 is a cross-sectional view of a phosphor layer of a modification of the second embodiment (a sixth modification).

FIG. 12 is a schematic cross-sectional view of an LCD device according to a third embodiment.

FIG. 13 is a schematic cross-sectional view of a liquid crystal panel of the third embodiment.

FIG. 14 is a cross-sectional view of a light source-side substrate (a phosphor layer) of the third embodiment.

FIG. 15 is a schematic cross-sectional view of an LCD device according to a fourth embodiment.

FIG. 16 is a schematic cross-sectional view of a light source-side substrate (a phosphor layer) of the fourth embodiment.

### DESCRIPTION OF EMBODIMENTS

Configurations of liquid crystal display (LCD) devices according to embodiments of the present invention will be described in detail below with reference to the accompanying drawings. The present invention is not limited to the following first to fourth embodiments.

### First Embodiment

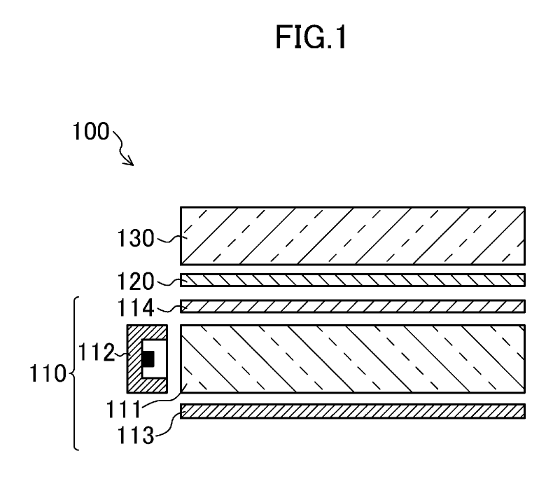

As shown in FIG. 1, an LCD device 100 of the first embodiment includes a light source unit 110, a phosphor layer 120, and a liquid crystal panel 130. The light source unit 110, the phosphor layer 120, and the liquid crystal panel 130 are arranged so that light emitted from the light source unit 110 is incident on the liquid crystal panel 130 through the phosphor layer 120 and predetermined image display is obtained on the display side of the liquid crystal panel 130. This LCD device 100 is used for, e.g., display devices of televisions, office automation (OA) apparatuses such as a personal computer, portable information apparatuses such as a mobile phone and a personal digital assistant (PDA), etc.

The light source unit 110 is of an edge light type in which a light-emitting diode (LED) light source 112 is provided on a lateral side of a light guide plate 111 so that light enters the light guide plate 111 from an end face of the light guide plate 111.

The light guide plate 111 is formed so as to have, e.g., a prism-shaped surface on the opposite side from the display side (the side of the phosphor layer 120). The light guide plate 111 is configured so that the light incident on the end of the light guide plate 111 is refracted by the prism-shaped surface and is emitted toward the display side (the side of the phosphor layer 120). A reflective sheet 113 is provided on the opposite side of the light guide plate 111 from the display side, and an optical sheet 114 is provided on the display side of the light guide plate 111.

The LED light source 112 has a function to emit light into the light guide plate 111. Preferably, the LED light source 112 is, e.g., a light source that emits light in a blue wavelength range with an emission peak wavelength of about 400-500 nm. This allows the emitted light to be used as it is for blue display. Since the light in the blue wavelength range does not include ultraviolet (UV) light (a wavelength of less than about 400 nm), light in the UV range need not be blocked. Accordingly, higher light utilization efficiency can be achieved as compared to the case where white light is used as a light source. Moreover, due to the phenomenon (Stokes shift) in which a peak position of a fluorescence emission spectrum is located on the longer wavelength side than an excitation light emission spectrum because of energy loss of excitation light etc., the blue light having a short wavelength can be preferably used as excitation light that produces fluorescence of red and green.

Instead of the LED light source 112, a fluorescent lamp such as a cold cathode tube and a hot cathode tube may be used as a light source.

The reflective sheet 113 has a function to reflect toward the light guide plate 111 the light that has leaked from the opposite side of the light guide plate 111 from the display side (the side of the phosphor layer 120).

The optical sheet 114 has a function to change orientation characteristics of the light emitted from the light guide plate 111. The optical sheet 114 is formed by stacking together, e.g., one to four prism sheets, diffusion sheets, etc. The optical sheet 114 is not an essential component, and may be omitted.

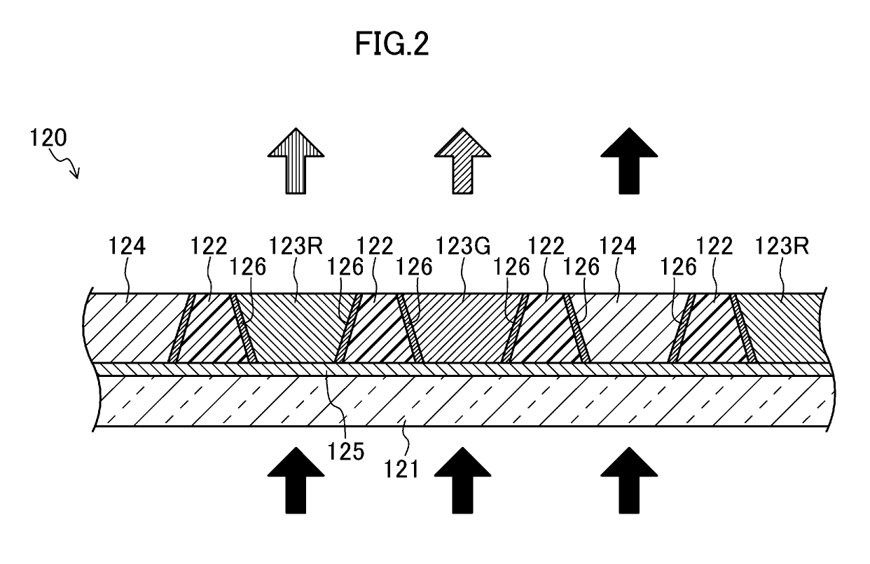

As shown in FIG. 2, the phosphor layer 120 has partition walls 122 that are formed over a substrate body 121 so as to separate pixel regions from each other. Phosphors 123R, 123G and fillers 124 are provided in the regions that are separated from each other by the partition walls 122. A bottom reflective layer 125 is provided on a surface of the substrate body 121, and side reflective layers 126 are provided on sidewalls of the partition walls 122.

The substrate body 121 is comprised of, e.g., a transparent material such as glass or transparent resin. The substrate body 121 has a thickness of, e.g., about 0.03-1.0 mm.

The partition walls 122 are comprised of, e.g., a resin such as acrylic or urethane acrylate. The partition walls 122 are formed so that the sidewalls are tilted with respect to the substrate body 121. The sidewalls are tilted to have a tapered shape in cross section so that the partition walls 122 are tapered toward the display side as viewed in cross section. The sidewalls of the partition walls 122 are tilted at an angle of, e.g., about 30-80 degrees with respect to the substrate body 121. The height to which the partition walls 122 protrude from the substrate body 121 is, e.g., about 5-20 μm.

As the phosphors 123R, 123G, red and green phosphors 123R, 123G are provided in the red and green pixel regions, respectively. The red phosphor 123R is comprised of a fluorescent material having a function to convert blue light to red light. The green phosphor 123G is comprised of a fluorescent material having a function to convert blue light to green light. Each fluorescent material is a fluorescent dye dispersed in a resin such as acrylic resin or UV-curable resin, or a solid solution of a fluorescent dye in a resin such as acrylic resin or UV-curable resin. The phosphors 123R, 123G have a thickness of, e.g., 5-20 μm. The phosphors 123R, 123G can be formed by using, e.g., an inkjet method.

The fillers 124 are provided so as to correspond to the blue pixel regions. The fillers 124 can be comprised of a resin material that transmits at least blue light therethrough, and is comprised of, e.g., a transparent resin material such as acrylic. The fillers 124 have dispersed therein, e.g., scattering particles that change orientation characteristics of blue light. This allows the fillers 124 to diffuse incident blue light. The fillers 124 have a thickness of, e.g., 5-20 μm. The fillers 124 can be formed by using, e.g., an inkjet method.

The bottom reflective layer 125 is a bandpass filter that transmits only the light in the blue wavelength range therethrough. The bandpass filter is configured so that, e.g., a high refractive index material and a low refractive index material are alternately stacked together to form about several tens of layers. The bandpass filter has a thickness of, e.g., about 2-5 μm. The bandpass filter can be formed by, e.g., vapor deposition or sputtering of TiO₂ and SiO₂.

The side reflective layers 126 are comprised of a material that is highly reflective in a visible light range, such as Al, Ag, an Al alloy, an Ag alloy, etc., and are formed on the sidewalls of the partition walls 122. The side reflective layers 126 have a thickness of, e.g., 50-500 nm The side reflective layers 126 can be formed by using, e.g., a sputtering method, vapor deposition, etc. The side reflective layers 126 are formed on such sidewalls of the partition walls 122 that are provided to have a predetermined tilt angle. This allows the side reflective layers 126 to reflect fluorescence produced by the phosphors 123R, 123G toward the display side even if the fluorescence travels toward the partition walls 122.

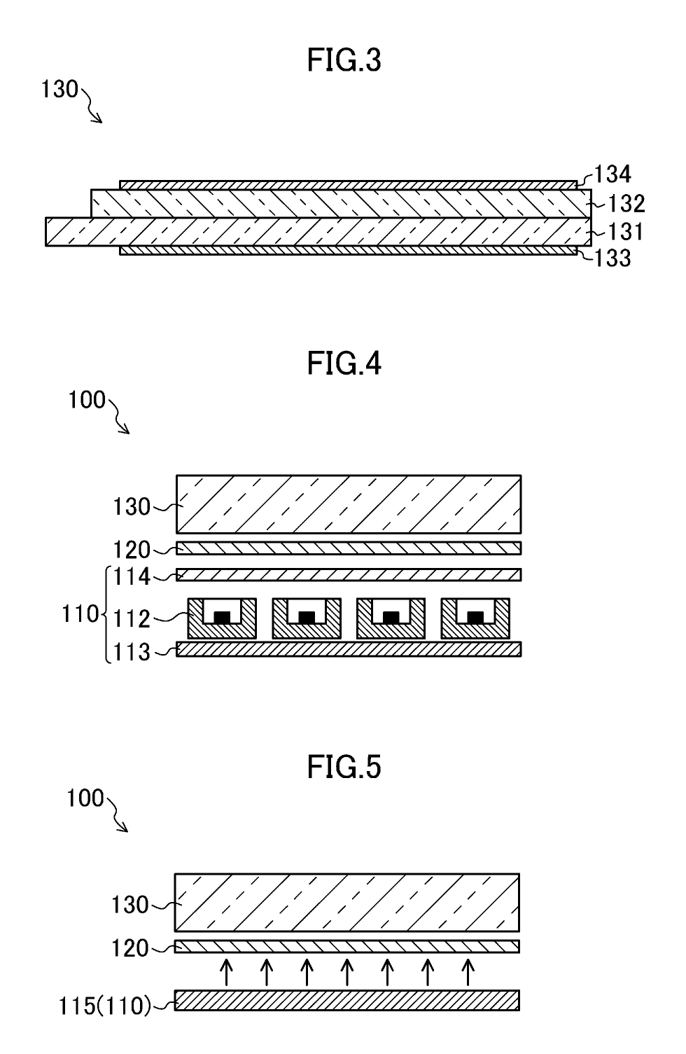

The liquid crystal panel 130 has a function as an optical shutter unit that controls on a pixel-by-pixel basis the transmittance of the light entering the liquid crystal panel 130 from the side of a light source-side substrate 131 and emits the resultant light from the display side. As shown in FIG. 3, in the liquid crystal panel 130, the light source-side substrate 131 located on the side of the light source unit 110, and a display-side substrate 132 located on the side from which the light is output (the display side) are arranged so as to face each other, and a liquid crystal layer (not shown) is enclosed in the space between these substrates. Polarizing layers 133, 134 are provided on a surface of the light source-side substrate 131 and a surface of the display-side substrate 132, respectively. The liquid crystal panel 130 is a twisted nematic (TN) liquid crystal panel, a vertical alignment (VA) liquid crystal panel, etc.

The light source-side substrate 131 is an array substrate in which gate metals and source metals are arranged on a substrate body to form switching elements such as thin film transistors (TFTs) for each pixel, pixel electrodes respectively electrically connected to the switching elements are formed for each pixel, and an alignment film is formed so as to cover the substrate body, the switching elements, and the pixel electrodes. The light source-side substrate 131 has a thickness of, e.g., about 0.1-1.0 mm.

The display-side substrate 132 has a configuration in which a counter electrode is provided over the entire surface of a substrate body, and an alignment film is formed so as to cover the counter electrode. The display-side substrate 132 has a thickness of, e.g., about 0.1-1.0 mm.

In the LCD device 100 having the above configuration, light emitted from the light source unit 110 is converted in the phosphor layer 120 to fluorescence of a wavelength of a predetermined color. The transmittance of the fluorescence incident on the optical shutter unit is adjusted on a pixel-by-pixel basis by the TFTs corresponding to the pixels, whereby a desired image is displayed as a whole.

(Advantages of First Embodiment)

According to the LCD device 100 having the above configuration, emitted light of the light source unit 110 is absorbed by the phosphors 123R, 123G of the phosphor layer 120 and is thus converted to fluorescence of a predetermined wavelength, whereby light of a desired color can be obtained. Accordingly, light loss is reduced as compared to a configuration in which light of a desired wavelength is output by transmitting emitted light of a light source unit through color filters. Specifically, in the case of transmitting emitted light of a white light source unit through RGB color filters, light of blue and green wavelengths is typically blocked if only light of a red wavelength is transmitted through the red color filter. Thus, only a maximum of ⅓ of the emitted light can be transmitted to the display side. In the LCD device 100, however, the light wavelength is converted to a predetermined one by the phosphors 123R, 123G, whereby light loss can be significantly reduced. Thus, high-luminance light emission can be obtained, and power consumption of the light source unit 110 can be suppressed. Moreover, according to the LCD device 100 having the above configuration, the bottom reflective layer 125 is provided on the side of the light source unit 110 in the region where the phosphor layer 120 is formed. Thus, of the fluorescence of a predetermined wavelength, which is obtained by the phosphor layer 120, the light traveling toward the light source unit 110 can be reflected to the opposite side from the light source unit 110 (the display side) by the bottom reflective layer 125. This improves fluorescence output efficiency, whereby high luminance characteristics can be obtained.

(Modifications of First Embodiment)

The first embodiment is described with respect to an example in which the light source unit 110 is of an edge light type. However, as shown in FIG. 4 as a first modification, the light source unit 110 may be of, e.g., a direct type in which a plurality of LED light sources 112 are arranged in parallel in a light-emitting surface of the light source unit 110 to emit light toward the phosphor layer 120. Alternatively, as shown in FIG. 5 as a second modification, the light source unit 110 may be formed by an organic EL light-emitting body 115 having a planar light-emitting surface and emitting light toward the phosphor layer 120.

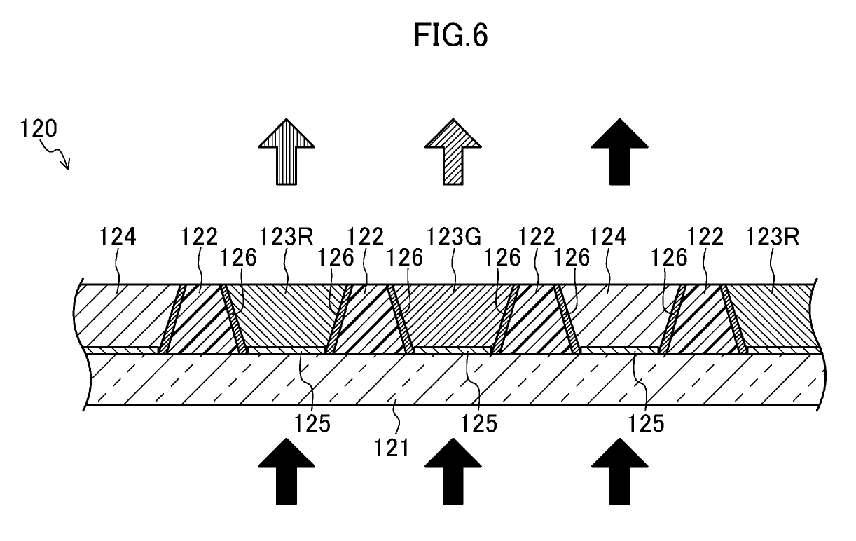

The first embodiment is described with respect to an example in which the bottom reflective layer 125 is provided on the entire surface of the substrate body 121. However, as shown in FIG. 6 as a third modification, the bottom reflective layer 125 need only be provided at least in the regions between the partition walls 122 on the surface of the substrate body 121, where the phosphors 123R, 123G are provided.

The first embodiment is described with respect to an example in which the display-side substrate 132 is a counter substrate having no color filter. However, color filters may be formed on the counter substrate. In this case, the color filters may be arranged so that red light and green light that are excited and emitted by the phosphor layer 120 pass through the red and green color filters, respectively, and blue light pass through the blue color filter. This can increase color purity of light of each color, RGB, which has passed through the color filters. However, light loss is caused when the light of each color, RGB, passes through the color filters. Accordingly, in order to improve light utilization efficiency, it is preferable not to form the color filters on the counter substrate.

The first embodiment is described with respect to an example in which the light source-side substrate 131 of the liquid crystal panel 130 is an array substrate and the display-side substrate 132 of the liquid crystal panel 130 is a counter substrate. However, the light source-side substrate 131 may be a counter substrate, and the display-side substrate 132 may be an array substrate.

### Second Embodiment

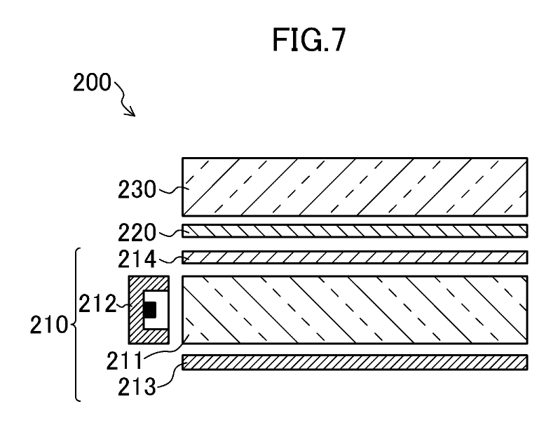

FIG. 7 shows an LCD device 200 according to the second embodiment. As in the first embodiment, this LCD device 200 is formed by a light source unit 210, a phosphor layer 220, and a liquid crystal panel 230 as an optical shutter unit.

As in the first embodiment, the light source unit 210 is of an edge light type in which an LED light source 212 is provided on a lateral side of a light guide plate 211 so that light enters the light guide plate 211 from an end face of the light guide plate 211. A reflective sheet 213 is provided on the opposite side of the light guide plate 211 from the display side, and an optical sheet 214 is provided on the display side of the light guide plate 211.

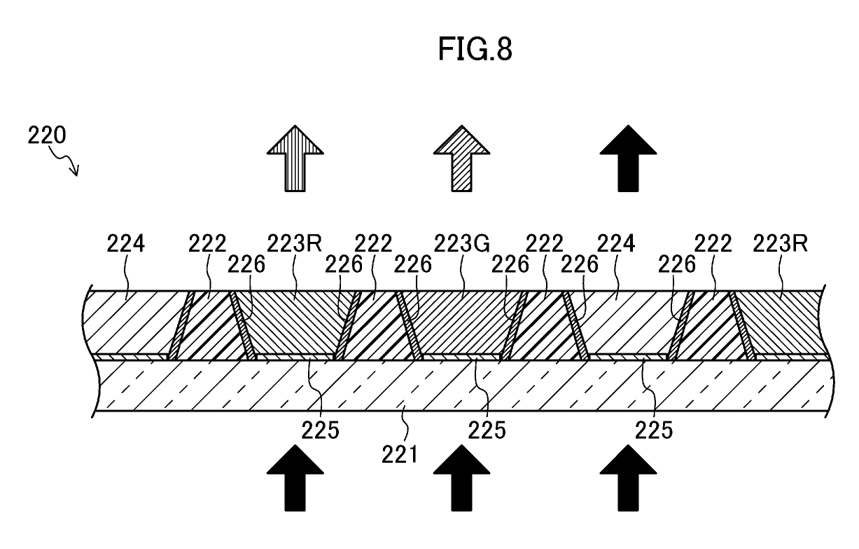

As in the first embodiment, as shown in FIG. 8, the phosphor layer 220 has partition walls 222 that are formed over a substrate body 221 so as to separate pixel regions from each other. Phosphors 223R, 223G and fillers 224 are provided in the regions that are separated from each other by the partition walls 222. Bottom reflective layers 225 are provided on a surface of the substrate body 221, and side reflective layers 226 are provided on sidewalls of the partition walls 222.

The bottom reflective layers 225 are films comprised of a low refractive index material, and have a thickness of, e.g., about 0.2-1.0 μm. An example of the low refractive index material is a fluororesin having a refractive index of about 1.35-1.40. In the case where the substrate body 221 is comprised of glass (a refractive index of about 1.52) and the phosphors 223R, 223G are comprised of an acrylic resin (a refractive index of about 1.49), the substrate body 221 has a higher refractive index than the phosphors 223, and thus light traveling from the phosphors 223 toward the substrate body 221 is not reflected and all of the light is incident on the substrate body 221 if the phosphor layer 220 has a conventional configuration having no bottom reflective layer. However, if the bottom reflective layers 225 are provided, a critical angle at which light is incident on the bottom reflective layers 225 from the phosphors 223R, 223G or the fillers 224 is about 64 degrees. Accordingly, even if light excited by the phosphors 223R, 223G or light scattered by the fillers 224 travels toward the bottom reflective layers 225, the light incident on the bottom reflective layers 225 from the phosphors 223R, 223G or the fillers 224 at an angle equal to or larger than the critical angle is totally reflected back to the phosphors 223R, 223G or the fillers 224. Thus, a large part of the light excited by the phosphors 223R, 223G can be directed toward the display side, thereby reducing the possibility that fluorescence produced by the phosphors 223R, 223G may return to the light source and the light utilization efficiency may be reduced.

Moreover, since the bottom reflective layers 225 are formed as single-layer films of a low refractive index material, the bottom reflective layers 225 having a small thickness can be provided at low cost.

The same materials etc. as those of the first embodiment can be used for the configuration other than the bottom reflective layers 225.

As in the first embodiment, the liquid crystal panel 230 has a function as an optical shutter unit that controls on a pixel-by-pixel basis the transmittance of light entering the liquid crystal panel 230 from the side of the light source unit 210 and emits the resultant light from the display side. Although not shown in detail in the figures, in the liquid crystal panel 230, a light source-side substrate located on the side of the light source unit 210, and a display-side substrate located on the side from which the light is output (the display side) are arranged so as to face each other, and a liquid crystal layer is enclosed in the space between these substrates. Polarizing layers are provided on a surface of the light source-side substrate and a surface of the display-side substrate, respectively.

(Advantages of Second Embodiment)

According to the LCD device 200 having the above configuration, the following advantage can be obtained in addition to the advantages obtained by the LCD device 100 of the first embodiment. Since the bottom reflective layers 225 are comprised of a low refractive index material, the bottom reflective layers 225 having a small thickness can be formed at low cost.

(Modifications of Second Embodiment)

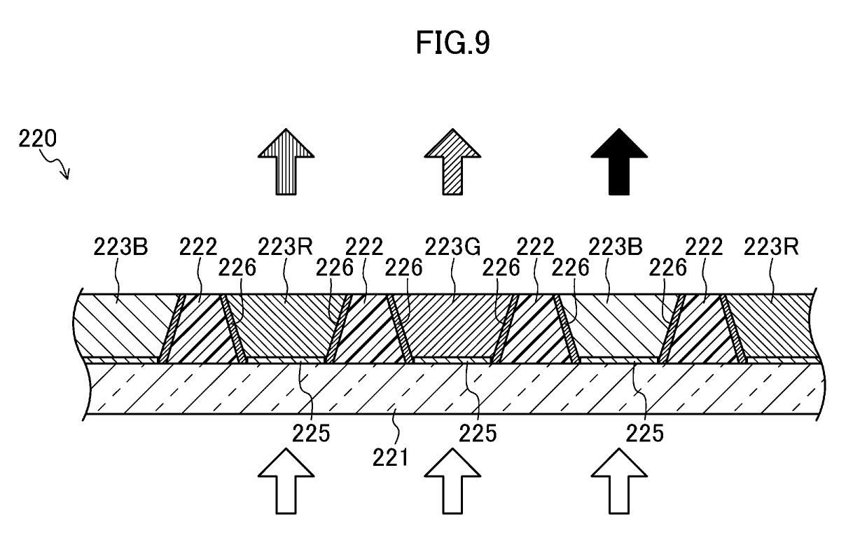

The second embodiment is described with respect to an example in which a blue light source is used as the light source unit 210. However, the present invention is not particularly limited to this, and the LCD device 200 may be formed by using a white light source as a light source unit. In this case, as shown in FIG. 9 as a fourth modification, in order to obtain light emission of each color, RGB, red, green, and blue phosphors 223R, 223G, 223B are arranged as the phosphor layer 220 so as to correspond to the pixel regions.

The second embodiment is described with respect to an example in which the light source unit 210 is of an edge light type. However, as in the first embodiment, the light source unit 210 may be of a direct type having a plurality of LED light sources 212, or may be formed by a surface-emitting organic EL light-emitting body.

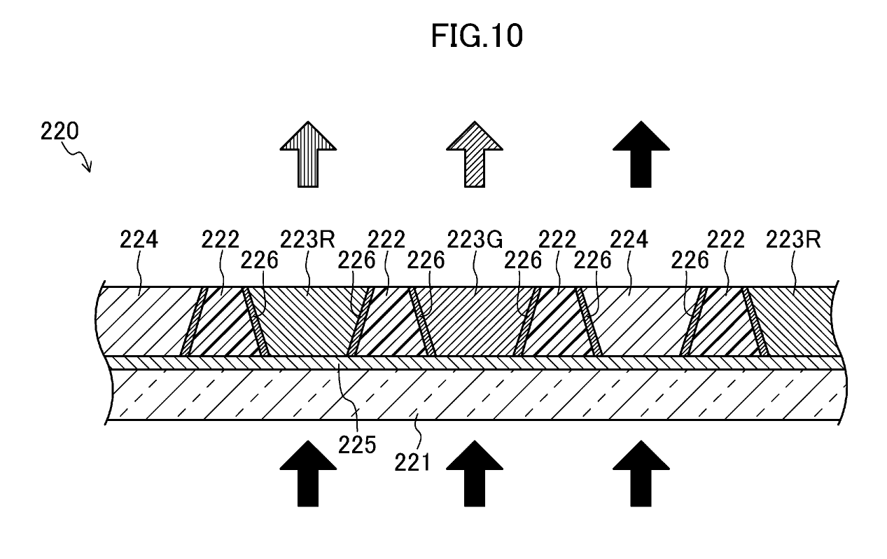

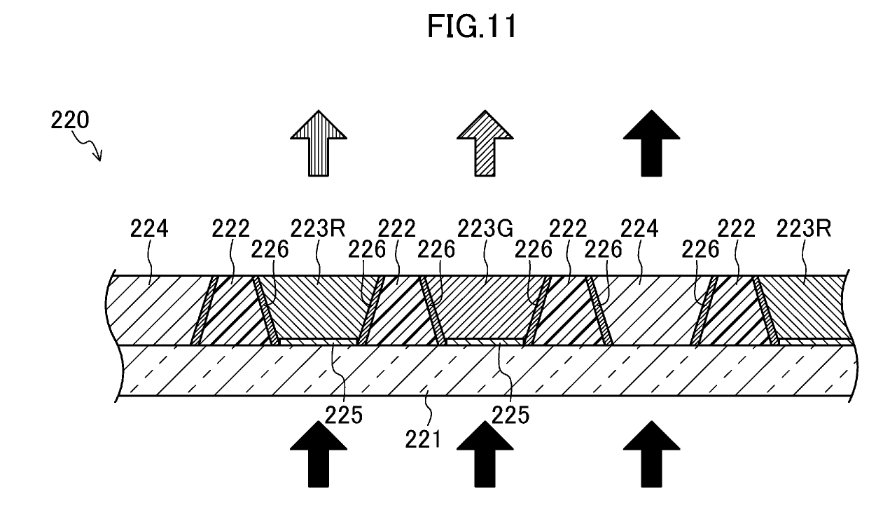

The second embodiment is described with respect to an example in which the bottom reflective layers 225 are provided below the phosphors 223R, 223G and the fillers 224. However, the present invention is not particularly limited to this. For example, as shown in FIG. 10 as a fifth modification, the bottom reflective layer 225 may be formed so as to cover the entire surface of the substrate body 221. Alternatively, as shown in FIG. 11 as a sixth modification, the bottom reflective layers 225 may not be provided below the fillers 224, and may be provided only below the phosphors 223R, 223G.

### Third Embodiment

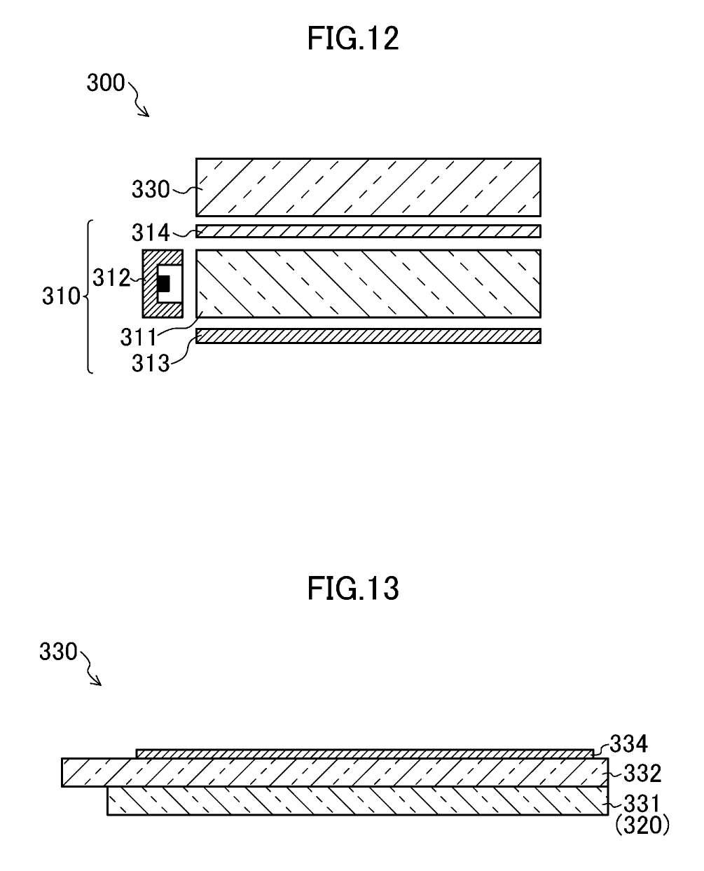

FIG. 12 shows an LCD device 300 according to a third embodiment. This LCD device 300 is formed by a light source unit 310 and a liquid crystal panel 330 as an optical shutter unit.

As in the first embodiment, the light source unit 310 is of an edge light type in which an LED light source 312 is provided on a lateral side of a light guide plate 311 so that light enters the light guide plate 311 from an end face of the light guide plate 311. A reflective sheet 313 is provided on the opposite side of the light guide plate 311 from the display side, and an optical sheet 314 is provided on the display side of the light guide plate 311.

The liquid crystal panel 330 has a function as an optical shutter unit that controls on a pixel-by-pixel basis the transmittance of the light entering the liquid crystal panel 330 from the side of the light source unit 310 and emits the resultant light from the display side. As shown in FIG. 13, in the liquid crystal panel 330, a light source-side substrate 331 located on the side of the light source unit 310, and a display-side substrate 332 located on the side from which the light is output (the display side) are arranged so as to face each other, and a liquid crystal layer (not shown) is enclosed in the space between these substrates. A polarizing layer 334 is provided on a surface of the display-side substrate 332.

The light source-side substrate 331 is configured to function as a phosphor layer 320 as well.

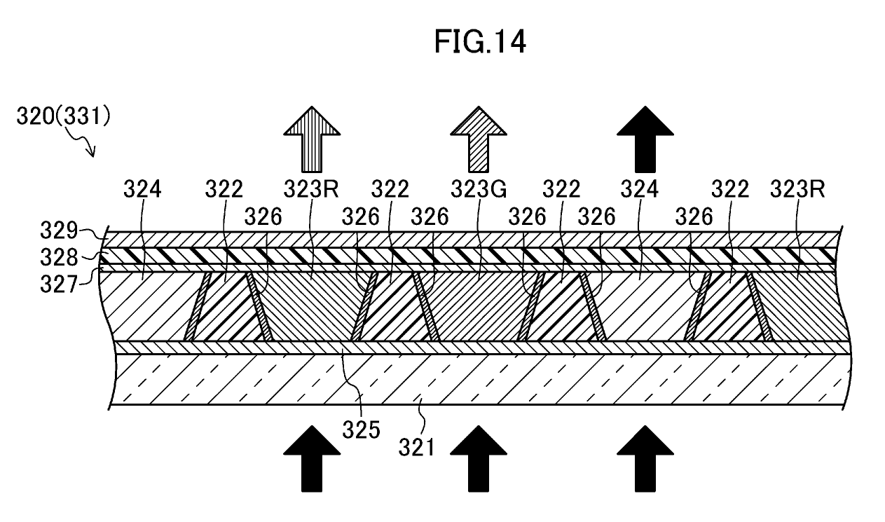

As shown in FIG. 14, the light source-side substrate 331, namely the phosphor layer 320, has a bottom reflective layer 325 provided on a substrate body 321, and partition walls 322 formed so as to separate pixel regions from each other. Phosphors 323R, 323G and fillers 324 are provided in the regions that are separated from each other by the partition walls 322. Side reflective layers 326 are provided on sidewalls of the partition walls 322. Moreover, a polarizing layer 327 is provided so as to cover the partition walls 322, the phosphors 323R, 323G, and the fillers 324, and a transparent insulating film 328, a transparent conductive film (a counter electrode) 329, and an alignment film (not shown) are stacked on the polarizing layer 327.

The substrate body 321, the partition walls 322, the phosphors 323R, 323G, the fillers 324, and the side reflective layers 326 can be comprised of the same materials etc. as those of the first embodiment. The bottom reflective layer 325 may be a bandpass filter as in the first embodiment, or may be comprised of a low refractive index material as in the second embodiment.

The polarizing layer 327 is preferably a wire grid in which thin metal wires are periodically formed parallel to each other. In this case, the polarizing layer 327 polarizes light by using its function to reflect light of an electric field vector that is parallel to the thin metal wires in a wire grid surface and to transmit therethrough light of an electric field vector that is perpendicular to the thin metal wires in the wire grid surface.

The transparent insulating film 328 is comprised of, e.g., an acrylic resin, SiO₂, etc., and has a thickness of, e.g., about 0.1-1.0 μm. The transparent conductive film 329 is comprised of, e.g., indium tin oxide (ITO) etc., and has a thickness of, e.g., about 0.05-0.3 μm. The transparent conductive film 329 is provided on the entire surface of the substrate, and functions as a counter electrode that is held at a constant potential.

The display-side substrate 332 is an array substrate in which gate metals and source metals are arranged on a substrate body to form switching elements such as thin film transistors (TFTs) for each pixel, pixel electrodes respectively electrically connected to the switching elements are formed for each pixel, and an alignment film is formed so as to cover the substrate body, the switching elements, and the pixel electrodes.

(Advantages of Third Embodiment)

According to the LCD device 300 having the above configuration, the following advantage can be obtained in addition to the advantages obtained by the LCD device 100 of the first embodiment and the LCD device 200 of the second embodiment. Since the light source-side substrate 331 functions as the phosphor layer 320 as well, the overall thickness of the LCD device can be reduced.

### Fourth Embodiment

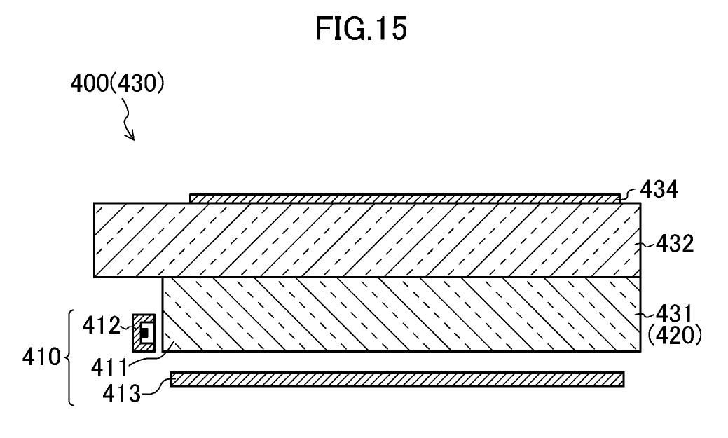

FIG. 15 shows an LCD device 400 according to the fourth embodiment. This LCD device 400 is formed by a liquid crystal panel 430 as an optical shutter unit, and a reflective sheet 413 is provided on a surface of the LCD device 400 which is located on the opposite side from the display side.

As shown in FIG. 15, in the liquid crystal panel 430, a light source-side substrate 431 and a display-side substrate 432 located on the side from which light is output (the display side) are arranged so as to face each other, and a liquid crystal layer (not shown) is enclosed in the space between these substrates. A polarizing layer 434 is provided on a surface of the display-side substrate 432.

The light source-side substrate 431 is configured to function as both a light source unit 410 and a phosphor layer 420.

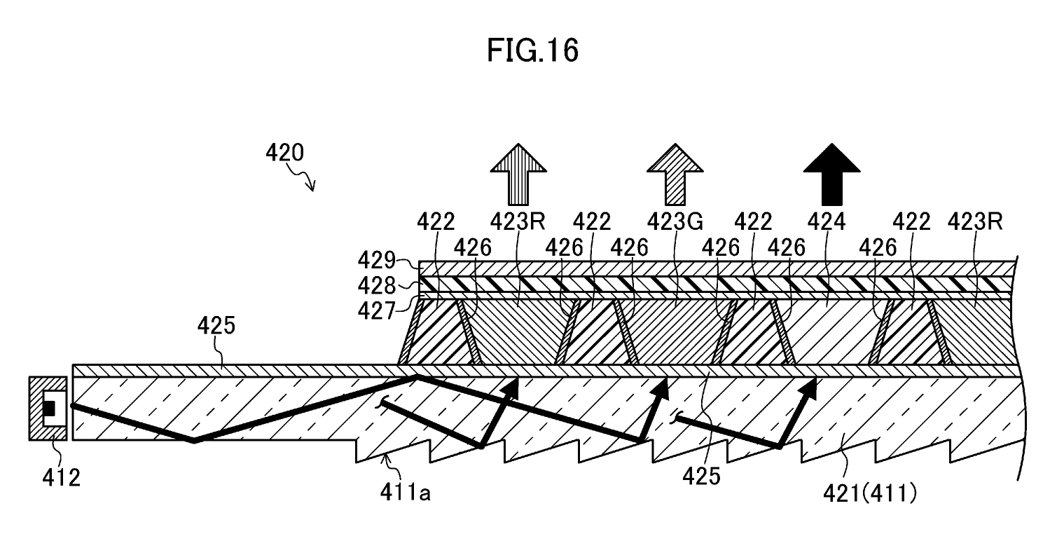

As shown in FIG. 16, the light source-side substrate 431 has a bottom reflective layer 425 provided on a substrate body 421, and partition walls 422 formed so as to separate pixel regions from each other. Phosphors 423R, 423G and fillers 424 are provided in the regions that are separated from each other by the partition walls 422. Side reflective layers 426 are provided on sidewalls of the partition walls 422. Moreover, a polarizing layer 427 is provided so as to cover the partition walls 422, the phosphors 423R, 423G, and the fillers 424, and a transparent insulating film 428, a transparent conductive film (a counter electrode) 429, and an alignment film (not shown) are stacked on the polarizing layer 427.

The substrate body 421 functions as a light guide plate 411 of the light source unit 410 as well, and has a zigzag prism-shaped bottom surface 411a. The substrate body 421 forms the light source unit 410 of an edge light type in which an LED light source 412 is provided on a lateral side of the substrate body 421 as the light guide plate 411 so that light enters the substrate body 421 from an end face of the substrate body 421, and the light incident on the substrate body 421 from the end face thereof is reflected by the bottom surface 411a. The reflective sheet 413 is placed on a surface of the substrate body 421 (the light guide plate 411).

The partition walls 322, the phosphors 423R, 423G, the fillers 424, the side reflective layers 426, the polarizing layer 427, the transparent insulating film 428, and the transparent conductive film 429 can be comprised of the same materials etc. as those of the third embodiment.

As in the second embodiment, the bottom reflective layer 425 is a film comprised of a low refractive index material. Since the bottom reflective layer 425 is comprised of the low refractive index material, the light incident on the substrate body 421 from the LED light source 412 located at an end of the substrate body 421 (the light guide plate 411) can be totally reflected by the interface between the light guide plate 411 and the bottom reflective layer 425 to travel in the light guide plate 411, and then can be reflected by the prism-shaped bottom surface 411a toward the phosphor layer 420, as shown in FIG. 16.

As in the third embodiment, the display-side substrate 432 is an array substrate in which gate metals and source metals are arranged on a substrate body to form switching elements such as thin film transistors (TFTs) for each pixel, pixel electrodes respectively electrically connected to the switching elements are formed for each pixel, and an alignment film is formed so as to cover the substrate body, the switching elements, and the pixel electrodes.

(Advantages of Fourth Embodiment)

According to the LCD device 400 having the above configuration, the following advantage can be obtained in addition to the advantages obtained by the LCD device 300 of the third embodiment. Since the light source-side substrate 431 is configured to function as both the light source unit 410 and the phosphor layer 420, the overall thickness of the LCD device can be reduced.

### INDUSTRIAL APPLICABILITY

The present invention is useful for display devices that provide color display, and particularly for high luminance or low power consumption display devices having improved utilization efficiency of light emitted from a light source.

DESCRIPTION OF REFERENCE CHARACTERS

| | |
|---|---|
| 100, 200, 300, 400 | LCD Device |
| 110, 210, 310, 410 | Light Source Unit |
| 111, 211, 311, 411 | Light Guide Plate |
| 112, 212, 312, 412 | LED Light Source |
| 120, 220, 320, 420 | Phosphor Layer |
| 121, 221, 321, 421 | Substrate Body |
| 122, 222, 322, 422 | Partition Wall |
| 123G, 223G, 323G, 423G | Green Phosphor (Phosphor) |
| 123R, 223R, 323R, 423R | Red Phosphor (Phosphor) |
| 124, 224, 324, 424 | Filler |
| 125, 225, 325, 425 | Bottom Reflective Layer |
| 126, 226, 326, 426 | Side Reflective Layer |
| 130, 230, 330, 430 | Liquid Crystal Panel (Optical Shutter Unit) |
| 131, 331, 431 | Light Source-Side Substrate |
| 132, 332, 432 | Display-Side Substrate |

1. A display device, comprising:
a light source unit configured to emit light from a light emitting surface; and
a phosphor layer having a plurality of phosphors provided on a light-emitting side of the light source unit so as to correspond to pixels, and configured to absorb the light emitted from the light source unit and produce fluorescence of a predetermined wavelength, wherein
a bottom reflective layer is provided at least on regions of the phosphor layer where the phosphors are formed, and is located on a side of the light source unit with respect to the phosphor layer.

2. The display device of claim 1, wherein
the plurality of phosphors are separated from each other by a partition wall having a sidewall that is tilted to have a tapered shape in cross section so that the partition wall is tapered toward a display side as viewed in cross section, and
a side reflective layer is provided on the sidewall of the partition wall.

3. The display device of claim 1, wherein
the light source unit emits light in a blue wavelength range.

4. The display device of claim 3, wherein
the pixels include red pixels, green pixels, and blue pixels, and
the phosphor layer includes
red phosphors placed so as to correspond to the red pixels, and configured to absorb light of a blue wavelength to emit fluorescence of a red wavelength,
green phosphors placed so as to correspond to the green pixels, and configured to absorb the light of the blue wavelength to emit fluorescence of a green wavelength, and
fillers placed so as to correspond to the blue pixels, and configured to transmit therethrough the light of the blue wavelength to an opposite side of the light source unit.

5. The display device of claim 3, wherein
the bottom reflective layer is a bandpass filter configured to transmit therethrough only the light in the blue wavelength range emitted from the light source unit.

6. The display device of claim 1, wherein
the bottom reflective layer is comprised of a low refractive index material.

7. The display device of claim 1, further comprising:
an optical shutter unit provided on an opposite side of the phosphor layer from the light source unit, and configured to control on a pixel-by-pixel basis transmittance of emitted light of the phosphor layer to a display side.

8. The display device of claim 7, wherein
the optical shutter unit is configured so that two substrates are arranged so as to face each other with a liquid crystal layer interposed therebetween.

9. The display device of claim 7, wherein
the light source unit is of an edge light type that is formed by a light guide plate, and a light source provided on a lateral side of the light guide plate and configured to emit light toward the light guide plate.

10. The display device of claim 7, wherein
the light source unit is of a direct type that is formed by a plurality of light sources arranged in parallel and configured to emit light toward the phosphor layer.

11. The display device of claim 7, wherein
the light source unit is formed by an organic EL light-emitting body configured to emit light toward the phosphor layer.

12. The display device of claim 1, further comprising:
an optical shutter unit configured so that a light source-side substrate and a display-side substrate are arranged so as to face each other, and configured to control on a pixel-by-pixel basis transmittance of emitted light of the phosphor layer to a display side, wherein
the phosphor layer is formed on the light source-side substrate, and
the light source unit is placed on a side of the light source-side substrate with respect to the optical shutter unit.

13. The display device of claim 12, wherein
a liquid crystal layer is provided between the light source-side substrate and the display-side substrate.

14. The display device of claim 12, wherein
the light source unit is of an edge light type that is formed by a light guide plate, and a light source provided on a lateral side of the light guide plate and configured to emit light toward the light guide plate.

15. The display device of claim 12, wherein
the light source unit is of a direct type that is formed by a plurality of light sources arranged in parallel and configured to emit light toward the phosphor layer.

16. The display device of claim 12, wherein
the light source unit is formed by an organic EL light-emitting body configured to emit light toward the phosphor layer.

17. The display device of claim 1, further comprising:
an optical shutter unit configured so that a light source-side substrate and a display-side substrate are arranged so as to face each other, and configured to control on a pixel-by-pixel basis transmittance of emitted light of the phosphor layer to a display side, wherein
the light source unit is of an edge light type that is formed by a light guide plate, and a light source provided on a lateral side of the light guide plate and configured to emit light toward the light guide plate, and
the phosphor layer is formed on a side of the light guide plate which is located on the display side, so that the phosphor layer and the light source unit together form the light source-side substrate.

18. The display device of claim 17, wherein
a liquid crystal layer is provided between the light source-side substrate and the display-side substrate.
